(19) United States
(12) Patent Application Publication
(10) Pub. No.: US 2002/0083024 A1
(43) Pub. Date: Jun. 27, 2002

(54) Case management system and method

(76) Inventor: Bradley A. Myers, Salem, OH (US)

Correspondence Address: BENESCH, FRIEDLANDER, COPLAN & ARONOFF LLP, ATTN: IP DEPARTMENT DOCKET CLERK, 2300 BP TOWER, 200 PUBLIC SQUARE, CLEVELAND, OH, 44114, US

(21) Appl. No.: 09/992,537

(22) Filed: Nov. 19, 2001

Related U.S. Application Data
(60) Provisional application No. 60/249,818, filed on Nov. 17, 2000.

(51) Int. Cl. G06F 17/00

(52) U.S. Cl. 705/500

(57) ABSTRACT

A computer-implemented method for managing an investigation case comprising receiving a case from a client, assigning an investigator to the case; and managing the case on behalf of the client and the investigator by a case manager.

### CROSS-REFERENCE TO RELATED APPLICATION

This application claims the benefit of U.S. Provisional Application No. 60/249,818, filed on Nov. 17, 2000.

### BACKGROUND OF THE INVENTION

Private investigative vendors throughout North America are not uniformly regulated. Clients in need of investigative services typically find it impossible to locate and screen private investigative vendors in every geographic area where investigative services are required. A search of the phone book can reveal that more than 50% of the numbers listed for investigative vendors are out of service. Furthermore, locating a private investigator doesn't guarantee that the particular private investigator meets minimum state requirements (if any have been established) or has proper insurance in place to protect both themselves and their clients. Most clients are seeking private investigator vendors who: (i) are properly licensed; (ii) carry the appropriate minimum amount of insurance; (iii) have a proven track record of success, and (iv) are able to furnish reporting and invoicing in a professional manner—all for an acceptable rate. Additionally, investigators sometimes have problems collecting fees and invoicing where clients prefer to have invoices generated according to a specific format.

Therefore, what is needed is a case management system and method where: (i) clients can remotely order and monitor investigation cases; (ii) a case manager locates and screens investigators in numerous geographic area; (iii) the case manager can assign an investigator to the case based on geographic area; (iv) investigators can remotely enter time and expenses regarding their investigation; and (v) the case manager can manage the administration functions of the investigation cases.

### SUMMARY OF THE INVENTION

The present invention provides a case management system and method for enabling a private investigator case manager (hereinafter referred to “case manager”) to efficiently manage a high volume of investigative cases. The system and method are implemented in part by software that runs on the case manager's Web site. In the present application, the term “case manager” can include any entity such as an individual, company, or employee of a company. The case manager performs a variety of functions including, but not limited to, client enrollment, investigative entity enrollment, and administrating the case initiation as well as acting as a liaison between the client and investigative entity for case status, billing and payment.

A case manager can serve in two very different capacities concerning the client. First, they can manage the case for the client. This is commonly referred to as a “reviewed” case, traditionally known in the industry as a Special Investigative Unit (SIU) function. This involves the client submitting a case to the case manager; the case manager assigning an investigator from the investigative network to handle the case, and the case manager managing the case on behalf of both the client and the investigator. A case manager reviews all time and expense entries entered by the investigator before they are approved. Any hard evidence in the form of videotapes, court records, etc. is forwarded directly to the client from the investigator to ensure a strong chain of evidence.

Secondly, the case manager can serve as a liaison between the client and the investigator. In this capacity, the client submits and assigns cases to the investigator directly. These cases are referred to as “live” cases. However, the client may choose to utilize the case manager investigative network or assign the case to an investigator they have added to their own preferred investigator list. Regardless of the investigator selected, the client and investigator are able to communicate directly regarding the file and once an investigator submits a time and expense entry, it is immediately approved and available for review by the client. In the event there is a problem between the client and investigator, a case manager is available to serve in a customer support role.

A computer-implemented method for managing an investigation case comprising receiving a case from a client, assigning an investigator to the case; and managing the case on behalf of the client and the investigator by a case manager.

### BRIEF DESCRIPTION OF THE DRAWINGS

These and other features, aspects, and advantages of the present invention will become better understood with regard to the following description, appended claims, and accompanying drawings where:

FIG. 1 is a high-level architectural drawing illustrating the primary components of a case management system that operates in accordance with the present invention;

FIG. 2 is an architectural drawing illustrating the client enrollment system in accordance with the present invention;

FIG. 3 is an architectural drawing illustrating the investigator enrollment system in accordance with the present invention;

FIG. 4 is a work flow diagram illustrating the case entry and assignment system in accordance with the present invention;

FIG. 5 is a work flow diagram illustrating the case progress system in accordance with the present invention; and

FIG. 6 is a work flow diagram illustrating the case reporting and invoicing system in accordance with the present invention.

### DETAILED DESCRIPTON OF THE INVENTION

To facilitate a complete understanding of the invention, the description of the preferred embodiment is arranged within the following sections:

1. GLOSSARY OF TERMS AND ACRONYMS

2. OVERVIEW OF SYSTEM COMPONENTS

3. CLIENT ENROLLMENT SYSTEM

4. INVESTIGATOR ENROLLMENT SYSTEM

5. CASE ENTRY AND ASSIGNMENT SYSTEM

6. CASE PROGRESS SYSTEM

7. REPORTS AND INVOICING SYSTEM

8. COMMUNICATION LOG SYSTEM

1. Glossary of Terms and Acronyms

The following terms and acronyms are used throughout the detailed description:

Client-Server Relationship. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

Hyperlink. A navigational link from one document to another, or from one portion (or component) of a document to another. Typically, a hyperlink is displayed as a highlighted word or phrase that can be selected by clicking on it using a mouse to jump to the associated document or documented portion.

Hypertext System. A computer-based informational system in which documents (and possibly other types of data entities) are linked together via hyperlinks to form a user-navigable “web.”

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web Site. A computer system that serves informational content over a network using the standard protocols of the World Wide Web. Typically, a Web site corresponds to a particular Internet domain name, such as “PI-TRACK.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

2. Overview of System Components

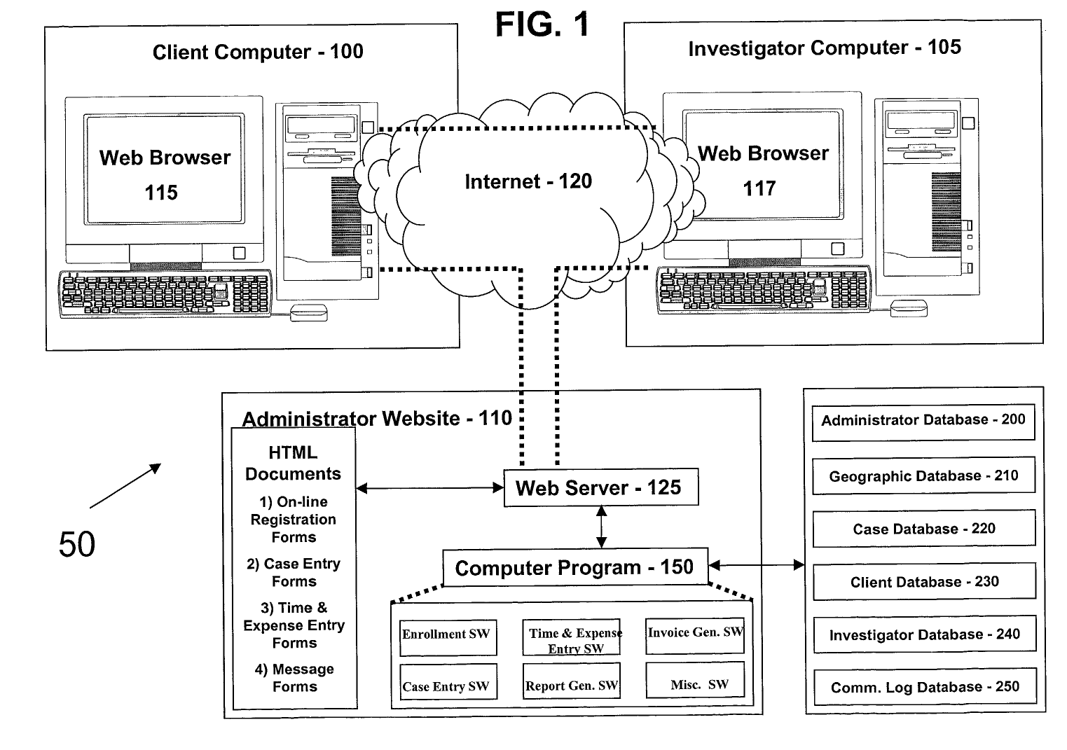

Referring now to the drawings where the illustrations are for the purpose of describing the preferred embodiment of the present invention and are not intended to limit the invention described herein, FIG. 1 illustrates the general architecture of a case management system that operates in accordance with the present invention. The system 50 preferably includes a client computer 100, an investigator computer 105, and a case manager Web site 110, all of which are linked together by the Internet 120.

The client computer 100 may be any type of computing device that allows a user (i.e., client) to interactively browse Web sites via a Web browser 115. The investigator computer 105 may be any type of computing device that allows a user (i.e., investigator) to interactively browse Web sites via a Web browser 117. For example, the client computer 100 or the investigator computer 105 may be a personal computer (PC), cell phone, Palm Pilot®, or any other personal digital assistant (PDA) that has Web-access capabilities. Preferably, the Web browsers 115 and 117 are equivalent to Microsoft's Internet Explorer 4.0 or higher or Netscape's Navigator 4.0 or higher.

The case manager Web site 110 is linked to a case manager web server 125 that has numerous databases stored within the server 125. Representative examples of the databases include administration 200, geographic administration 210, case 220, client 230, investigator 240, and communication log 250. However, any other database having a specific function could be stored within the server 125. The databases may be any type of data repository including, for example, an SQL table or ASCII text file. Preferably, the databases are Lotus Notes® databases. The case manager Web site 110 is a site that provides various functionality for allowing (i) clients to remotely submit cases via a client computer 100; (ii) investigators to remotely accept cases via an investigator computer 105; (iii) clients and investigators to track the status of their case via their respective computers; and (iv) the case manager to manage the cases on behalf of the clients and investigators. Typically, this Web site 110 will be operated by a business entity (i.e., case manager) that handles the various case assignment, management, invoicing, and customer service tasks associated with the management of investigation cases. In an implementation described herein, the case manager Web site 110 is the site of “PI-TRACK.com”.

In the preferred embodiment, the administration database 200 is the central repository for the infrastructure information in the system 50. The administration database 200 provides the ability to set up and change the default settings in the system 50. Preferably, the administration database is available only internally to the case manager for modifications. The administration database 200 may include the following information: system default values (e.g., hourly rates for case manager, case number, expense constant (i.e., amount by which hourly rates are “marked up” to allow for expenses)), expense types (e.g., name, flat rate for billing, and flat rates for reimbursement), case type, and case manager information. Although the administration database 200 according to the preferred embodiment includes the aforementioned information, other information may be stored within the administration database 200.

In the preferred embodiment, the geographic administration database 210 is used to store geographic area and market rate information. The geographic administration database 210 may include the following information: geographic regions, state information, county information, zip code information, and market rate information. Although the geographic administration database 210 according to the preferred embodiment includes the aforementioned information, other information may be stored within the geographic administration database 210. Preferably, the state, county, and zip code data is loaded into the database 210 from a data file supplied by the U.S. Postal Service. Preferably, the geographic administration database 210 will be designed to handle updates from the U.S. Postal Service files as supplied by subscription.

In the preferred embodiment, the case database 220 is used to store all information about case files. The case database 220 may include the following case information: case type profile (e.g., reviewed or live), primary client contact, completion due date, subject's first and last names, subject's zip code, budget amount, investigator selection, time entries, and expense entries. Preferably, the case database 220 stores additional information that may be entered by the client such as: trial/hearing date, subject's social security number, aliases, street or mailing address, phone number, date of birth, sex, marital status, spouse's name, race, children's names, history of violent behavior, represented by counsel, identity of counsel, alleged injury, date of loss, physical description of subject, physical restrictions, vehicles associated with subject, special instructions for the case, and client's internal reference number. Although the case database 220 according to the preferred embodiment includes the aforementioned information, other information may be stored within the case database 220.

In the preferred embodiment, the client database 230 is used to store all information about clients. The client database 230 may include the following client information: client name and address, client contact, client identification code, primary user account user name, lead case manager assigned to the client (including e-mail address and phone numbers), tax ID number, and tax exemption information. Although the client database 230 according to the preferred embodiment includes the aforementioned information, other information may be stored within the client database 230.

In the preferred embodiment, the investigator database 240 is used to store all information pertaining to investigators that are part of the case manager's investigator network or are part of the client's own preferred list of investigators. The investigator database 240 may include the following investigator information: investigator name and address, unique ID number, contact information, tax ID number, unique identifier indicating whether investigator is part of the case manager's investigator network, unique identifier indicating whether investigator is part of client's vendor list (if yes, then client's name, number and margin charged to the client are stored in this database), business license, errors and omissions insurance including coverage amount, and auto insurance. Although the investigators database 240 according to the preferred embodiment includes the aforementioned information, other information may be stored within the investigators database 240.

In the preferred embodiment, the communication log database 250 may be used to store all information related to communications between client and case manager, client and investigator, and case manager and investigator. The database 250 preferably tracks the day-to-day communications between the client, investigator, and case manager and stores the communication entries including the time and date stamps.

In the preferred embodiment and described in further detail below, the case manager Web site 110 includes enrollment software that implements an online registration process for allowing other entities (e.g., individuals, companies, etc.) to enroll as clients. An entity enrolling as a client provides the case manager Web site 110 with a completed, online registration application that is processed by enrollment software at the Web site 110. The enrollment software creates an entry in the client database 230 according to the information provided by the enrolling client.

Additionally, in the preferred embodiment and described in further detail below, the case manager Web site 110 includes enrollment software that implements an online registration process for allowing other entities (e.g., individuals, companies, etc.) to enroll as investigators. An entity enrolling as an investigator provides the case manager Web site 110 with a completed, online registration application that is processed by enrollment software at the Web site 110. The enrollment software creates an entry in the investigator database 240 according to the information provided by the enrolling investigator.

In the preferred embodiment and described in further detail below, the case manager Web site 110 includes case entry software that implements an online submission process for allowing clients to submit cases that require an investigation procedure. A client submitting a case requiring an investigation procedure provides, via Web browser 115, the case manager Web site 110 with a completed, online case entry submission that is processed by case entry software at the Web site 110. The case entry software creates an entry in the case database 220 according to the information provided by the client.

In the preferred embodiment and described in further detail below, the case manager Web site 110 includes communication software that enables the client and investigator to prepare communications via their respective computers by accessing the case manager Web site 110 and sending messages to the other parties. If the communication is a time and expense entry, the communication software creates an entry in the case database 220 according to the information provided by the client, investigator, or case manager. If the communication is a mere status update, the communication software creates an entry in the communication log database 250 according to the information provided by the client, investigator, or case manager.

3. Client Enrollment System

As indicated above, the case manager Web site 110 includes automated enrollment software (FIG. 1) for allowing an entity to enroll, via the Internet, as a client in need of investigative services. The registration process may include the following: (i) the presentation of an online business agreement to the applicants, (ii) the use of an automated “agent” to scan the application text for key inputted terms, including vulgarities and other terms that may serve as a basis for denying the application, and (iii) the automated generation and assignment of a unique client ID (also referred to herein as the “client ID”) to an applicant.

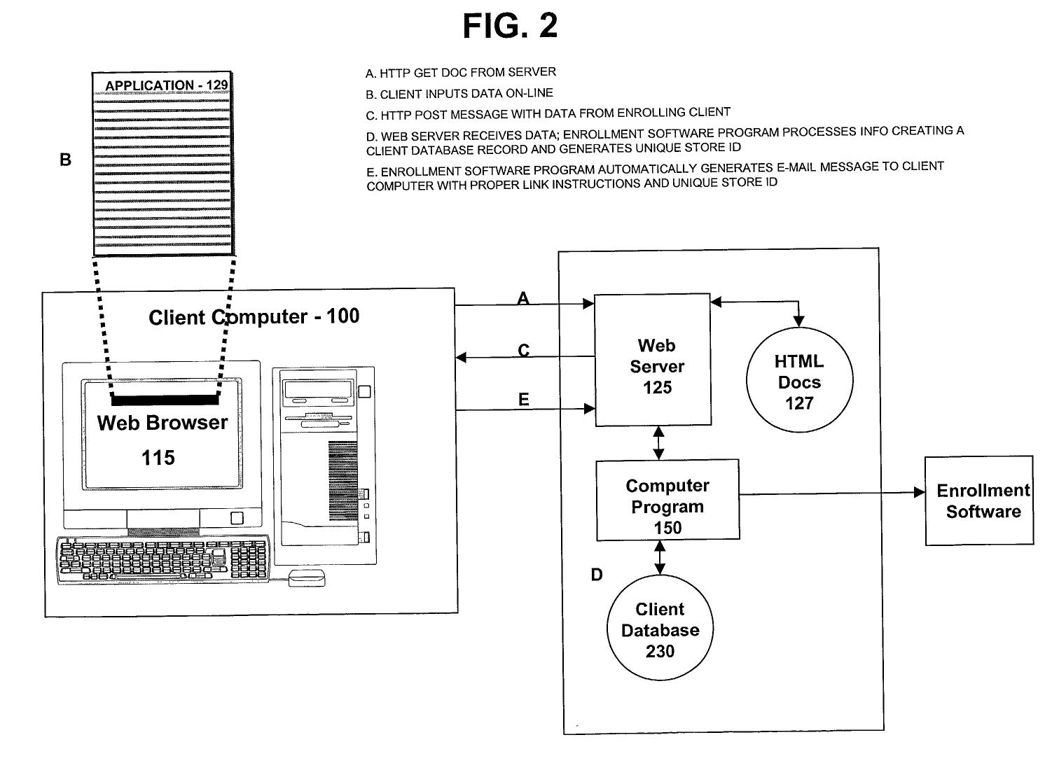

FIG. 2 illustrates the general flow of information between components when an applicant (e.g., individual, company, organization, etc.) uses a computer 100 to enroll as a client. Alternatively, a case manager can commence the enrollment process. The computer 100 includes a conventional Web browser 115 that communicates with the case manager Web server 125 using the HTTP or equivalent protocol. The Web server 125 accesses a local store of HTML documents (i.e., Web pages) 127 which can be requested, retrieved and viewed by the applicant via the Web browser 115. These documents may, for example, include information about registering online to become a client. Access to the case manager Web site 110 and the enrollment function is available to any client computer 100.

As further illustrated in FIG. 2, the enrolling client or the case manager begins the enrollment function by selecting the “Create New Client” hyperlink from the case manager Web page 110 containing online registration instructions. The case manager Web server 125 accesses a local store of HTML documents 127 and returns an online registration application form to the enrolling client's Web browser 115. The enrolling client or the case manager can then fill out the detailed online application form. The application requests information about the enrolling client, including the name, address, and e-mail address of the enrolling client. As will be appreciated by those skilled in the art, there are many possible formats to the online application form.

With further reference to FIG. 2, once the electronic application form is completed by the enrolling client, it is sent from the client's computer 100 to the case manager Web server 125 for further processing. As will be appreciated by those skilled in the art, other forms of enrollment processing may be used, including but not limited to telephone, facsimile, regular mail and electronic mail. In addition, although the automated enrollment function is preferably handled by the same computer system that handles the referral processing function, dedicated, physically distinct computer systems or sites could perform these functions.

In response to submission of the enrollment form, the case manager Web server 125 initiates a computer program 150 comprising enrollment software that processes the information contained on the electronic application form. In one embodiment, an agent is used to scan the application text for pre-specified terms, and to flag the application for further review (such as by a staff member) if such a term exists. If no such term is found, and the application is complete, the enrollment software will accept the application if the certain criteria are met. For example, the criteria may include a rating system based on certain minimum credit rating, properly completed form, and other necessary administrative information.

As part of this online registration, once the application has been processed (either automatically or with human intervention), the enrollment software generates a unique client ID to be assigned to the client. In addition, the enrollment software creates a database entry corresponding to the enrolling client and stores the client ID and the information provided by the enrolling client as a unique entry in a client database 230. If a client of the case manager has different locations connecting directly to the system 50, then each client location will have a separate client ID and password to enter the system 50. All the client locations will be organized hierarchically in the system. A client location is permitted to view case information for itself and any locations below it in the hierarchy.

Next, the computer program 150 automatically formats and transmits an electronic mail message to the e-mail address of the approved client welcoming the client and including the unique client ID.

4. Investigator Enrollment System

As indicated above, the case manager Web site 110 includes automated enrollment software (FIG. 1) for allowing an entity to apply, via the Internet, to operate as a provider of investigative services (hereinafter referred to as “investigator”). Investigators may include sole proprietorship investigators, partnerships, investigative companies, etc. The total enrollment of all the investigators is hereinafter referred to as the investigator network. The registration process may include the following: (i) the presentation of an online business agreement to the applicants, (ii) the use of an automated “agent” to scan the application text for key inputted terms, including vulgarities and other terms that may serve as a basis for denying the application, and (iii) the automated generation and assignment of a unique investigator ID (also referred to herein as the “investigator ID”) to an applicant.

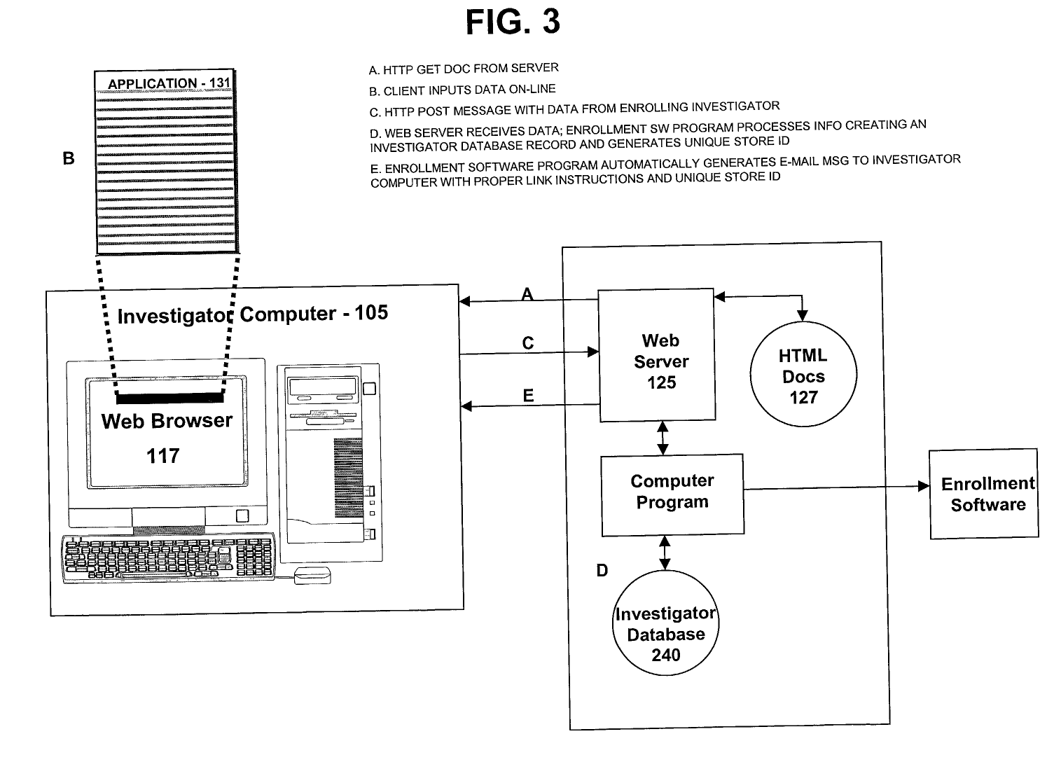

FIG. 3 illustrates the general flow of information between components when an applicant (e.g., individual, company, organization, etc.) uses a computer 105 to enroll as an investigator. Alternatively, a case manager can commence the enrollment process. The computer 105 includes a conventional Web browser 117 that communicates with the case manager Web server 125 using the HTTP or equivalent protocol. The Web server 125 accesses a local store of HTML documents (i.e., Web pages) 127 which can be requested, retrieved and viewed by the applicant via the Web browser 115. These documents may, for example, include information about registering online to become an investigator. Access to the case manager Web site 110 and the enrollment function is available to any investigator computer 105.

As further illustrated in FIG. 3, the enrolling investigator or the case manager begins the enrollment function by selecting the “Create New Investigator” hyperlink from the case manager Web page 110 containing online registration instructions. The case manager Web server 125 accesses a local store of HTML documents 127 and returns an online registration application form to the enrolling investigator's Web browser 117. The enrolling investigator or the case manager can then fill out the detailed online application.

The enrolling investigator or the case manager can then fill out the detailed online application form. The application requests information about the enrolling investigator, including the name, address, and e-mail address of the enrolling investigator. As will be appreciated by those skilled in the art, there are many possible formats to the online application form.

Investigators are categorized into a geographic area, which is a region across which market rates can be established. Geographic areas will commonly correspond to a metropolitan area, such as Youngstown-Warren, Ohio or Chicago, Ill. The system 50 preferably supports maintaining the following information about geographic areas: name, description (e.g., counties, cities, etc.), list of zip code ranges that define the geographic area, market rates (i.e., rates that the case manager charges clients for investigations in this geographic area), and rankings for the investigative companies that are authorized to perform investigations in the area. Investigators are only authorized to be enrolled in the system 50 if they meet certain criteria. These criteria include: a minimum amount of errors and omissions insurance, a minimum amount of automobile liability insurance, and a valid license in a state that requires a license. The topranked company will be designated the primary investigative company for the geographic area. The others will be referred to as secondary investigative companies. Case assignments are made preferentially to higher ranked companies.

If a client has one or more investigators they are currently using and desires to continue to do so, the client can instruct the investigators to enroll with the case manager as an investigator or can instruct the case manager to enroll the investigator. These investigators are known as preferred investigators because the client wishes to utilize in various geographic areas of the country. This feature preserves relationships that already exist between clients and investigators. Additionally, the client can continue to pay the same rate for investigative services from their preferred investigators that they paid prior to utilizing the system 50. Therefore, investigators can fall into one of three categories: 1) a preferred investigator who is not part of the case manager investigator network; 2) a preferred investigator who is also part of the case manager investigator network; and 3) an investigator who is part of the case manager investigator network, but is not a preferred investigator.

With further reference to FIG. 3, once the electronic application form is completed by the enrolling investigator, it is sent from the investigator's computer 105 to the case manager Web server 125 for further processing. As will be appreciated by those skilled in the art, other forms of enrollment processing may be used, including but not limited to regular mail and electronic mail. In addition, although the automated enrollment function is preferably handled by the same computer system that handles the referral processing function, dedicated, physically distinct computer systems or sites could perform these functions.

In response to submission of the enrollment form, the case manager Web server 125 initiates a computer program 150 comprising enrollment software that processes the information contained on the electronic application form. In one implementation, an agent is used to scan the application text for pre-specified terms, and to flag the application for further review (such as by a staff member) if such a term exists. If no such term is found, and the application is complete, the enrollment software will accept the application if the certain criteria are met.

As part of this online registration, once the application has been processed (either automatically or with human intervention), the enrollment software generates a unique investigator ID to be assigned to the investigator. In addition, the enrollment software creates a database entry corresponding to the enrolling investigator and stores the investigator ID and the information provided by the enrolling investigator as a unique entry in a investigator database 240. If an investigator has different locations connecting directly to the system 50, then each investigator location will have a separate investigator ID and password to enter the system 50. All the investigator locations will be organized hierarchically in the system. Any investigator location is allowed to see case information for itself and any locations below it in the hierarchy.

Next, the computer program 150 automatically formats and transmits an electronic mail message to the e-mail address of the approved investigator welcoming the investigator and including the unique investigator ID.

5. Case Entry and Assignment System

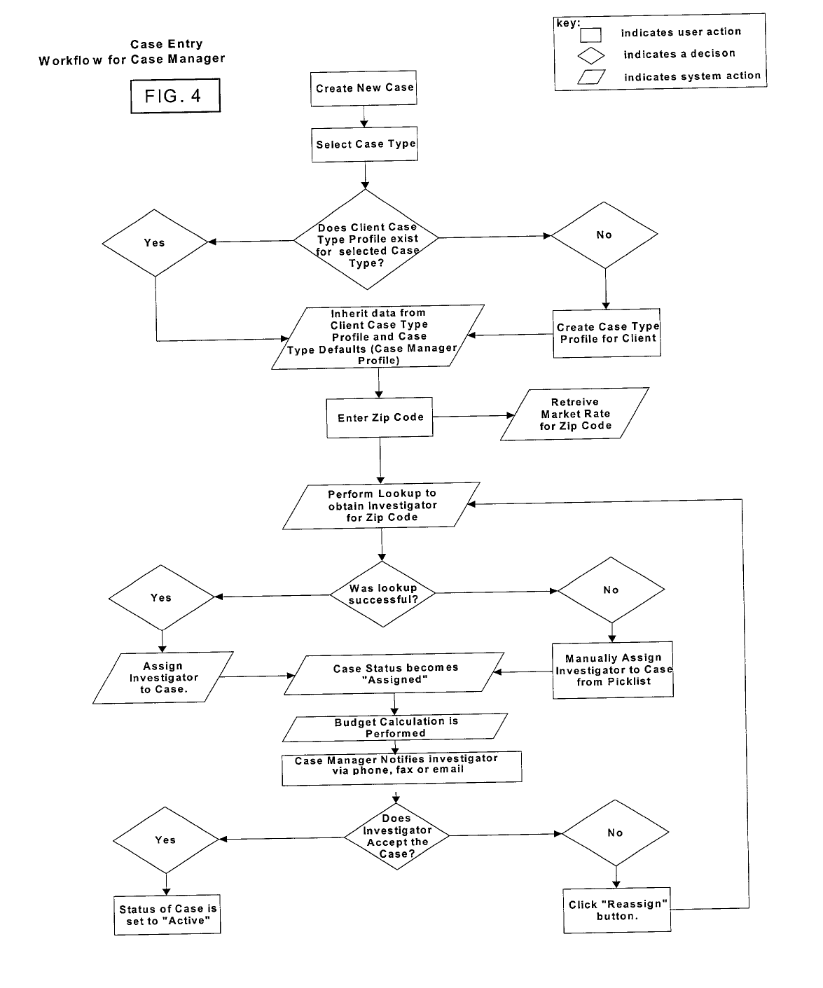

Once the clients and investigators are enrolled into the system 50, cases may be submitted by a client directly or by a case manager acting on behalf of the client via the case manager's Web site 110. As further illustrated in FIG. 4, the client or case manager begins the case entry function by selecting the “Create New Case” hyperlink from the case manager Web site 110 containing online case entry instructions. The case manager Web server 125 accesses a local store of HTML documents 127 and returns an online case entry form to the client's Web browser 115. Access to the case manager Web site 110 and the case entry function is available to any client computer 100.

After the client enters a valid client ID and password, the client will be prompted to enter the case type profile. Once the case type profile (i.e. reviewed or live) is selected, the client will be prompted to enter additional information that includes the following information: (i) budget type, and (ii) billing frequency. If the case type profile already exists for the selected case type, then the system 50 inherits the data from the existing client case type profile and defaults. If the case type profile does not exist for the selected case type, then a new case type profile for that client must be created. Once the case type profile has been created, specific information regarding the case must be entered onto the form which may include primary client contact, completion due date, subject's first and last names, subject's zip code, budget amount, detailed instructions to the investigator, and investigator selection. The investigator selection only applies if the client has a list of preferred investigators from which to choose from. In this case, the client may select one of their preferred investigators or select the case manager investigator network that will allow the case manager to assign an investigator for the client.

Before submitting the case, the client is reminded that submitting the case will bind them to the case contractual terms, at which time the client can proceed with submitting the case or terminate. If the client chooses to submit the case, the case will appear as “Pending Acceptance”, until the investigator accepts the case.

Once the case has been submitted, an investigator is assigned to the case. Cases can be assigned either manually or automatically. If the case type profile is to be automatically assigned to an investigator, the system 50 will identify the geographic area for the case based on the subject's (or facility's) zip code. Based on the geographic area, the case will be assigned to an investigator. Preferably, the investigator assigned will be the primary investigator for the geographic area. However, an investigator will be disqualified if: (i) no valid insurance policy is recorded or the insurance policy has not been verified within the required period; or (ii) the subject's address is in a state that requires statewide licensing and the investigative company does not have a valid license for that state recorded in the system or the license has not been verified within the required period.

A case can be assigned manually in two ways. First, if a case is designated as a “live” case, the functionality exists to select an investigator from a list of preferred investigators established for the client. Secondly, a case may not have been automatically assigned to an investigator because there is no appropriate geographic area or there is no investigator. If an investigator is not found, the status of the case becomes “Unassigned.” It may be necessary to locate and qualify a new investigator before the case can be assigned. If a case is “Unassigned”, the case manager assigned to the client will be prompted to select a valid investigator and assign one manually. This assignment will occur by clicking on the “Assign Investigator” button, which displays a list of investigators form the Investigators database. Selection is narrowed down by first selecting a state and then by selecting a geographic region or country.

When a case is assigned to an investigator, the time and expense budget for the case is then calculated and the case is marked a status of “Assigned”. The budget is calculated using rates based on the geographic area of the subject's (or facility's) address or the geographic area assigned to the case if no subject or facility address is entered. The budget includes the allotted time, mileage, and expenses that the investigator may expend. If a case is closed and then reassigned to a different investigator, then each investigator can view, add, and edit only their own time entries associated with the case. Also, each investigator can see only its own rates and payments due. The case manager will be required to allocate the budget between the investigator. The case may take an investigator out of the geographic area, but the rates applied will still be the rates for the original geographic area. An internal budget is set for work performed by the case manager based on the standard case manager charges for the case type.

Once a new case has been assigned, the system 50 will notify the investigator that a case has been assigned to them. Although notification may take place in the form of a phone call or facsimile, the preferred form is via e-mail which provides a hyperlink to the appropriate document via the case manager's Web site 110. This notification process is performed automatically. Once the investigator clicks the hyperlink, they will be prompted for their investigator ID and password to enter the case manager's Web site 110. Upon validation of their sign-on, the investigator will be able to view generalities of the case including budget amount, due date, zip code of the subject, location of the client and instructions, as well as the case contractual terms. However, they are unable to view specific information concerning the subject's name, social security number and address, nor is specific client information visible. If the investigator decides to reject the case, they no longer have access to the case and an e-mail notification is returned to the client and the case manager of the rejection. If this happens, the client or case manager can choose to modify the case and reassign it or simply select another investigator. If the investigator elects to accept the case, the system 50 sets the status of the case to “Active” and prompts the investigator to indicate whether sales tax is required on the case. If sales tax is required, the investigator enters the appropriate tax amount and tax is assessed on the case. Following acceptance of the case, all information is made available to the investigator, at which time the investigator may begin to enter time and expense entries for procedures associated with the assignment.

6. Case Progress System

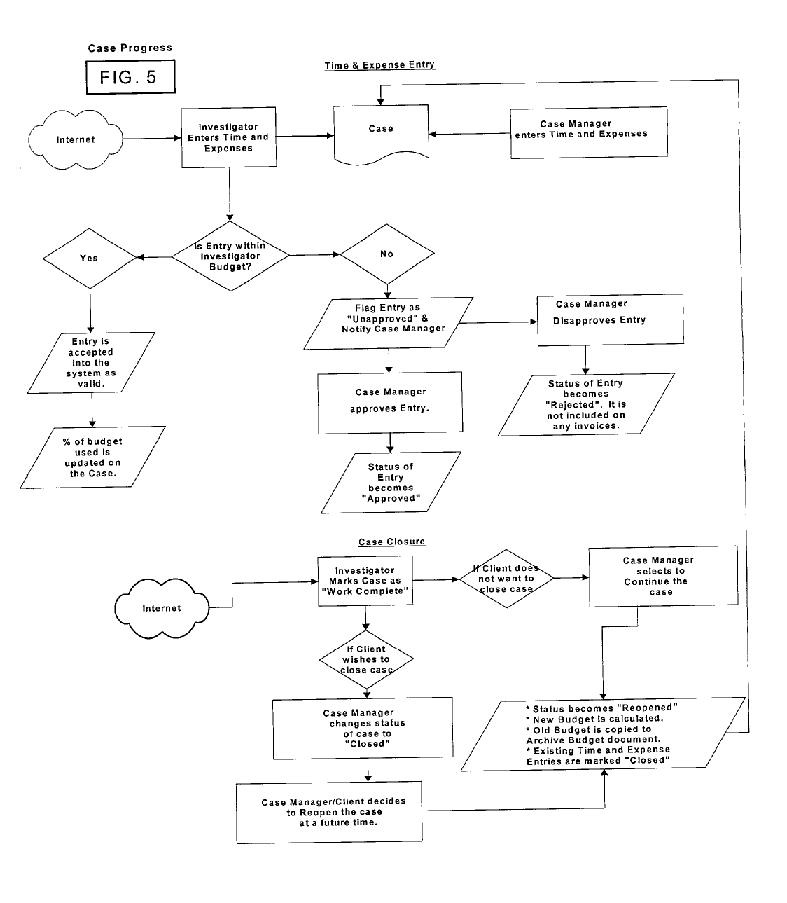

After performing the investigative work required, the investigator or case manager can submit time and expense entries for the investigative work performed as illustrated in FIG. 5. A client directly or the case manager may submit time and expense entries via the case manager's Web site 110. The client or case manager begins the case entry function by selecting the “Time and Expense Entry” hyperlink from the case manager Web site 110 containing online time and expense entry instructions. The case manager Web server 125 accesses a local store of HTML documents 127 and returns an online time and expense entry form to the investigator's Web browser 117.

Each entry will preferably contain: case, investigator's name, date, start time, end time, investigative time, travel time, mileage, detailed description of work, and expenses. Time and expense entries may only be entered for open (status of active) cases that have been assigned to the investigator.

If a case profile is “reviewed,” the system 50 will assign the entry a status of “New” meaning that the case requires review by a case manager. The case manager will be required to review time and expense entries submitted by the investigator only for “reviewed” cases. The case manager will be able to view the unique identifier of the time and expense entry. If the case is a “live” case, the status will automatically be set to “Approved.”

If an investigator enters a time and expense that is within the budget, the time and expense entry is accepted into the system 50 and the percentage of the overall budget will be calculated and updated within the system 50. If an investigator enters a time and expense entry that would cause the budget to be exceeded, the system 50 will allow the submission, but will flag the entry as “Unapproved.” The client and/or the case manager are then notified of the unapproved time and expense entry. At this time, the case manager may either reject the entry or consult the client on whether to edit the budget to accommodate the additional expense. The time and expense cannot be approved unless the budget is increased to accommodate the additional expense. If the client approves the budget increase to accommodate the additional expense, then the case manager approves the entry and the status of the entry becomes “Approved.” If the client does not approve the budget increase, then the case manager disapproves the time and expense entry and the status of the entry becomes “Rejected.” Upon rejection, the case manager enters the reason for the rejection, which is visible to both clients and investigators. Accordingly, the entry will neither be invoiced to the client nor reimbursed to the investigator.

After the investigator has accepted a case, finished all the work assigned, and entered all the time and expense entries, the investigator can close the case via accessing the case manager Web site 110. The investigator begins the closure function by selecting the “Case Completed” hyperlink from the case manager Web site 110 containing online case completion instructions. The case manager Web server 125 accesses a local store of HTML documents 127 and returns an online case completion form to the investigator's Web browser 117.

Once the investigator has finished all work assigned, he marks the file as “Work Complete” and the system 50 generates an automatic e-mail to the case manager and the client. After the investigator has placed the case in “Work Complete” status, the client can choose to either close the case or continue the case. If the client chooses to close the case, then the case manager will change the status of the case to “Closed.” After the case manager has marked the file “Closed,” the system 50 automatically generates an investigator statement. This statement outlines reimbursable charges due to the investigator for the investigative procedures performed on the case. The system 50 also generates a final invoice and final report.

If the client chooses to continue the case or if the case manager and/or client decide to reopen the case at a future time, the case manager selects the “Continue” hyperlink which will change the status of the case to “Reopened.” In this scenario, the system 50 generates a new budget and the old budget is copied to an archived budget document. Furthermore, the existing time and expense entries are marked “Closed.”

7. Reports and Invoicing System

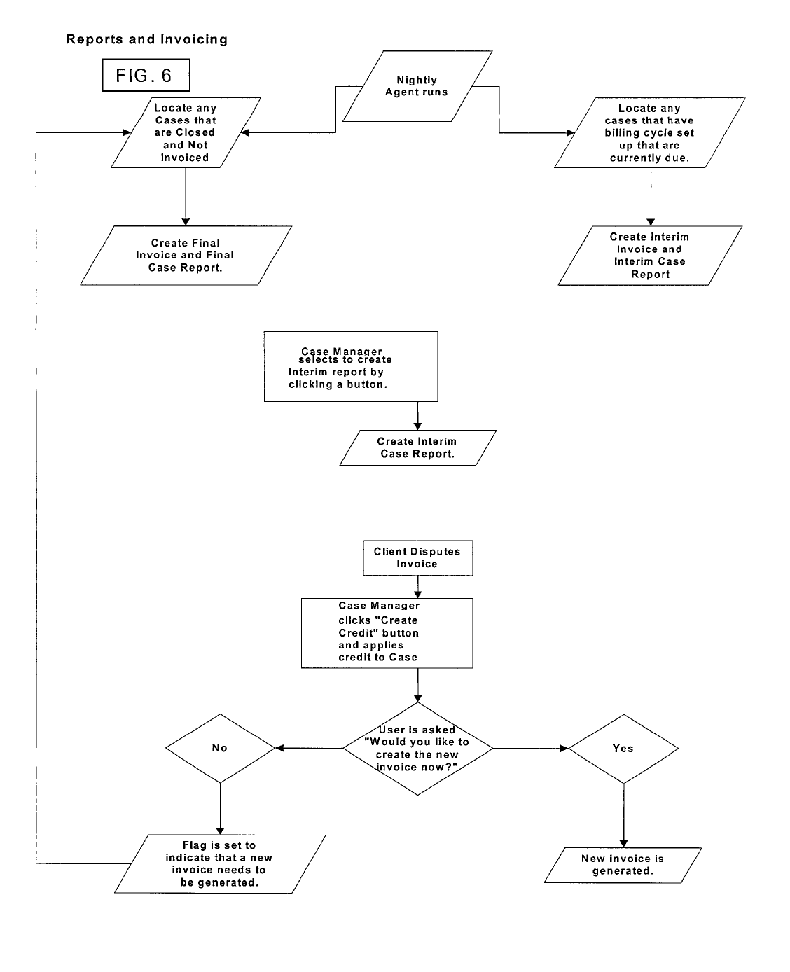

After performing the investigative work required, the investigator or case manager can request the system 50 to generate reports and invoicing for the investigative work performed as illustrated in FIG. 6. A client directly or the case manager may generate reports and invoices via the case manager's Web site 110. The client or case manager begins the case entry function by selecting either the “Generate Interim Report” or the “Generate Invoice” hyperlink from the case manager Web site 110 containing online report or invoice generation instructions. The case manager Web server 125 accesses a local store of HTML documents 127 and returns an online report request form or an online invoice request form to the client's Web browser 115. Preferably, the system 50 includes a nightly agent that generates an invoice periodically based on the billing frequency indicated in the client case type profile.

If the client chooses to generate a report, the report will include all the time entries for the case, chronologically ordered. The date, start and end times, description and hours will be included, but no dollar amounts will be displayed. The client has the option to include only entries since the last report was generated or all entries since the beginning of the case. The report will be identified as an “Interim Case Report” if the case is not closed and a “Final Case Report” if the case is closed. Preferably, the reports are standardized and uniform in appearance. With the present invention, the client does not need to sift through the numerous reporting styles and invoicing associated with utilizing many investigative vendors. All of the reports and invoices generated via the present invention are professional and uniform in appearance which greatly reduces the time needed to review investigative results.

If the client chooses to generate an invoice, the invoice will include all approved time and expense entries that have not been included on any previous invoice. Clients are invoiced on a regular basis for time and expenses recorded. Preferably, the case manager utilizes progress billing with its clients, not waiting until a case is closed. Invoicing is also standardized. Regardless of which investigative vendor the client selects, invoicing is professional and uniform, generated by PI-TRACK.COM. This also streamlines bookkeeping, as all payments for services are remitted to PI-TRACK.COM, who distributes payments to the appropriate investigative vendor. Preferably, all investigator payments will be done electronically through the PI-TRACK.COM Web site therefore strengthening the cash flow significantly for the investigator that traditionally lives day to day on their cash flow.

If a client disputes an entry on an invoice, a credit is added to the case as a special expense entry. The case manager clicks the “Create Credit” hyperlink from the case form to create this special entry. The user is also prompted to generate a new invoice. If the user selects “Yes,” the invoice is generated immediately. If the user selects “No,” then the invoice is generated by the nightly agent.

8. Communication Log System

The system 50 according to the present invention also has capabilities to provide communication between all the parties. A client, investigator, or case manager may generate communications via the case manager's Web site 110. The client, investigator, or case manager begins the case entry function by selecting the “Transmit Message” hyperlink from the case manager Web site 110. The case manager Web server 125 accesses a local store of HTML documents 127 and returns a message form to the respective client's, investigator's, or case manager's Web browser.

If a party chooses to transmit a message to the other party, the party will enter the message in the log and the message will be stored in the communications database 250 based on case number. Therefore, associated with each case will be a log of communications between the case manager, client and investigative company. These logs are designed to track the day-to-day communication between the case manager, client and investigative company.

Preferably, the case manager is able to review all entries to the communication log for the case regardless of who generated the entry or whom the entry was addressed to. Although the system 50 may have the capabilities to e-mail the person to whom a message was sent, the system will not support receiving e-mails from investigative companies or clients.

When the case manager receives a message from a client or investigator, he will have the opportunity to respond to the communication (i.e., creating another log entry) or to identify the communication as not requiring a response. The case manager will also have the ability to create a new log entry at any time. When a log entry is created by any party (case manager, investigator or client) the appropriate parties will be notified via an automatic e-mail generated by the system that a new entry has been created and will be provided a hyperlink to the new entry.

For security purposes, the entire system 50 provides a secure environment for the submission and transmission of information. All users are provided with a unique user name and password which grants them access only to the cases that they have submitted or been assigned. Also, both clients and investigators are able to establish a hierarchy of users within their own organization, granting privileges based on the needs of those users.

One skilled in the art of the present invention will appreciate that all case manager functions disclosed in the preferred embodiment herein can be performed not only via the Internet, but also may be performed via a standard client workstation view (i.e. locally or Intranet). Additionally, one skilled in the art will appreciate that the present invention can be applied to additional industries including, but not limited to, service, health care and insurance. Likewise, one skilled in the art will appreciate that the case manager, clients and investigators can be substituted for different parties or entities including, but not limited to corporations, general contractors, and sub-contractors.

While specific embodiments according to the present invention have been described and illustrated herein, it will be apparent to those skilled in the art that variations and modifications are possible, such alterations shall be understood to be within the broad spirit and principle of the present invention which shall be limited solely by the scope of the claims appended hereto.

What is claimed is:

1. A computer-implemented method for managing an investigation case, the method comprising:
a) receiving a case from a client;
b) assigning an investigator to the case; and
c) managing the case on behalf of the client and the investigator by a case manager.

2. The method of claim 1, wherein the step of receiving a case from a client comprises:
a) accessing a case entry form via the case manager Web site;
b) entering certain case information into the case entry form; and
c) submitting the case via the case manager Web site.

3. The method of claim 2, wherein the step of entering certain case information into the case entry form is accomplished by the client.

4. The method of claim 2, wherein the step of entering certain case information into the case entry form is accomplished by the case manager.

5. The method of claim 2, wherein the certain information is selected from the group consisting of case type profile, primary client contact, completion due date, subject's first and last names, subject's zip code, budget amount, and investigator selection.

6. The method of claim 1, wherein the investigator is assigned from an investigator network.

7. The method of claim 1, wherein the investigator is assigned from a preferred investigator list.

8. The method of claim 1, wherein the step of assigning the investigator to the case is automatic.

9. The method of claim 1, wherein the step of assigning the investigator to the case is manual.

10. The method of claim 1, wherein the step of assigning an investigator to the case comprises:
a) identifying a qualified investigator from an investigator network based on at least one parameter;
b) calculating a budget for the case; and
c) sending notification to the investigator requesting acceptance of the assignment to the case.

11. The method of claim 10, wherein the notification is an email message having a hyperlink associated with a case manager's Web site.

12. The method of claim 10, wherein the at least one parameter is a zip code of a subject being investigated.

13. The method of claim 10, wherein the qualified investigator has a valid insurance policy that is recorded and has a valid license in a state that requires an investigation license.

14. The method of claim 1, wherein the step of managing the case on behalf of the client and the investigator by a case manager comprises:
a) entering time and expense entries by the investigator; and
b) reviewing time and expense entries entered by the investigator.

15. The method of claim 1, wherein the step of managing the case on behalf of the client and the investigator by a case manager further comprises:
a) generating standardized reports and invoices regarding each case.

16. The method of claim 1, further comprising the steps of:
a) providing a client enrollment form via the case manager Web site to allow client applicants to enroll as clients; and
b) providing an investigator enrollment form via the case manager Web site to allow investigator applicants to enroll as investigators.

17. The method of claim 16, wherein the investigators are organized according to geographic area and zip codes within the geographic area.

18. A computer-implemented method for managing a service procedure provided by a subcontractor, the method comprising:
a) receiving a request for a service procedure from a customer;
b) assigning a sub-contractor to the service procedure; and
c) managing the service procedure on behalf of the customer and the sub-contractor by a manager.
